(19) United States
(12) Patent Application Publication
(10) Pub. No.: US 2015/0079863 A1
(43) Pub. Date: Mar. 19, 2015

(54) COMPOSITE FOR AND ARTICLE OF PROTECTIVE CLOTHING

(71) Applicant: Saint-Gobain Performance Plastics Corporation, Aurora, OH (US)

(72) Inventors: Debasis Majumdar, Manchester, NH (US); Ryan C. Hirschey, Nashua, NH (US); Jenna Reynolds, Merrimack, NH (US)

(21) Appl. No.: 14/455,679

(22) Filed: Aug. 8, 2014

Related U.S. Application Data
(60) Provisional application No. 61/864,334, filed on Aug. 9, 2013.

(51) Int. Cl. C09K 3/16; D06M 15/19; D06M 11/46; D06M 15/564

(52) U.S. Cl. CPC C09K 3/16; D06M 15/564; D06M 15/195; D06M 11/46
USPC 442/110; 252/500; 252/518.1; 252/519.5; 252/520.2; 252/520.1; 252/520.5; 252/520.4; 252/519.51

(57) ABSTRACT

The present disclosure is directed to composite or articles for protective clothing, which include an anti-static layer. The antistatic layer can 1), include an antistatic agent comprising an electronically conductive material, and the antistatic layer can have a visible light transmission of at least 70%; 2) the anti-static layer can have a surface electrical resistivity (SER), and/or a water electrode resistivity (WER) of no greater than 10¹¹ ohms/square and a visible light transmission of at least 70%; or 3) the anti-static layer has an electrical resistivity, measured in ohms/square, which varies by no more than 1.5 order of magnitude over a range of relative humidity of 5% to 95%, and a visible light transmission of at least 70%.

### CROSS-REFERENCE TO RELATED APPLICATION(S)

This application claims priority under 35 U.S.C. §119(e) to U.S. Patent Application No. 61/864,334 entitled “COMPOSITE FOR AND ARTICLE OF PROTECTIVE CLOTHING,” by Debasis Majumdar, Ryan C. Hirschey, and Jenna Reynolds, filed Aug. 9, 2013, which is assigned to the current assignee hereof and incorporated herein by reference in its entirety.

### FIELD OF THE DISCLOSURE

The present disclosure relates to composites for protective clothing, and more particularly to, articles of protective clothing including an anti-static layer.

### RELATED ART

Accumulation of static charge on the surface of insulating materials, such as those used in protective clothing, can lead to subsequent discharge creating an electric spark that can ignite a chemically explosive gas resulting in a potentially severe fire and injuries. Currently, protective clothing having anti-static layers containing ionically conducting anti-static agents or carbon black have been used. However, each type of anti-static agent has drawbacks. For example, ionically conducting anti-static agents, such as inorganic or organic salts, are not humidity independent, and can only provide the necessary anti-static effect in humid environments. Moreover, such ionically conducting anti-static agents are easily washed off during laundering, and therefore ineffective in reusable applications. Further, carbon black does not have transparency, and consequently, the protective clothing must be black, which is not a desirable color for protective clothing.

For at least these reasons, a need exist to provide new composites for protective clothing and articles of protective clothing that overcomes these notable drawbacks.

### BRIEF DESCRIPTION OF THE DRAWINGS

Embodiments are illustrated by way of example and are not limited in the accompanying figures.

FIG. 1 includes an illustration of a composite according to an embodiment of the present disclosure.

FIG. 2 includes an illustration of a composite according to another embodiment of the present disclosure.

FIG. 3 includes an illustration of a composite according to another embodiment of the present disclosure.

FIG. 4 includes an illustration of a composite according to another embodiment of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the protective clothing and anti-static arts.

The present disclosure is directed to composites and articles of protective clothing having an anti-static layer. The composites and articles of protective clothing can exhibit a synergistic combination of properties such as an excellent electrical resistivity, substantial transparency of the anti-static layer, humidity independence of the electrical resistivity, and combinations of these and other properties. The concepts are better understood in view of the embodiments described below that illustrate and do not limit the scope of the present invention

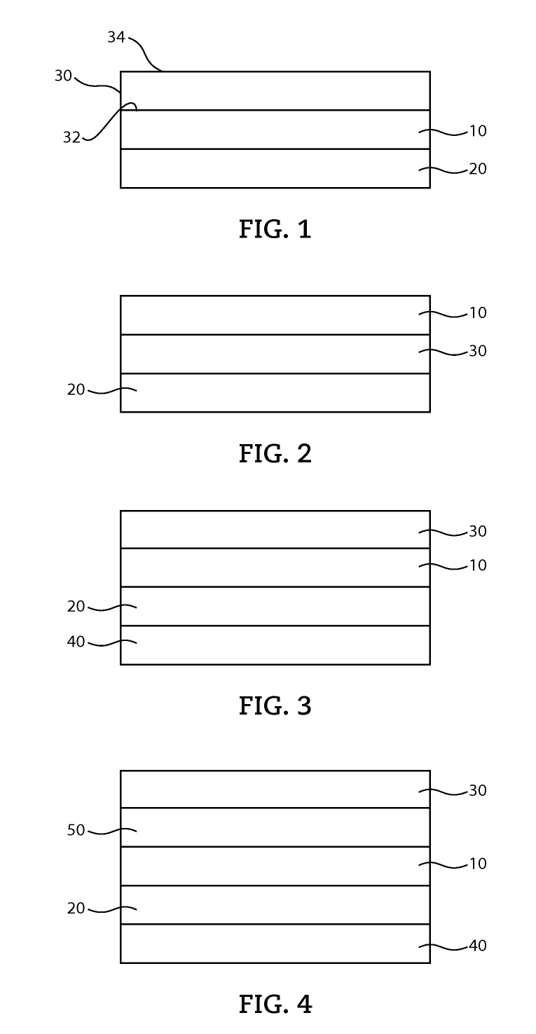

Referring to FIG. 1, there is illustrated a cross section view of a composite 1 for protective clothing according to an embodiment of the present disclosure. In certain embodiments, the composite 1 can include a chemically protective layer 20, a fabric layer 10, and an anti-static layer 30.

As illustrated in FIG. 1, the anti-static layer 30 can be an outermost layer of the composite 1. For example, the anti-static layer 30 can directly contact the fabric layer 10 on a first major surface 32, and the second major surface 34 can be exposed.

In other embodiments, as particularly illustrated in FIG. 2, the anti-static layer 30 can be disposed between the fabric layer 10 and the chemically protective layer 20. In particular embodiments, the anti-static layer 30 can directly contact the fabric layer 10 and the chemically protective layer 20. When the anti-static layer 30 is in direct contact with the fabric layer 10, it is to be understood that the anti-static layer 30 can be, at least partially impregnated into the fabric layer 10 or, in other embodiments, form an entirely separate and distinct layer.

The composite 1 can further include any number of additional layers in varying arrangement within the composite 1 depending on the intended use and specific materials employed. For example, in certain embodiments, the composite 1 can further include a thermoplastic layer 40, which can be disposed adjacent the chemically protective layer 20, as is illustrated in FIG. 3.

In another example, the composite can further include a flexible, elastomeric layer 50 as is illustrated in FIG. 4. The elastomeric layer 50 can be disposed between, and even directly contact, the fabric layer 10 and the anti-static layer 30.

It is to be understood that the aforementioned figures are for illustrative purpose only and may include any number of overlying, underlying or intervening layers or may not include all of the layers in the composite or article as is known in the art.

The fabric layer 10 can be constructed of any material useful in a composite for protective clothing. For example, the fabric may comprise polyester, nylon, polyolefin, carbon fiber, glass, Kevlar, Nomex, polyaramide, cotton, and the like. In particular embodiments, the fabric layer may include a woven, non-woven, spunbond, meltbond, knitfabric, or any combination thereof. In particular embodiments, the fabric layer 10 can include a woven material.

In some embodiments, the protective clothing may not incorporate a fabric layer. For example, in certain embodiments, the body and structure of the protective clothing material can be a polymeric layer instead of a fabric layer. The polymeric layer can be formed with any material useful for protective clothing, such as polyolefins like polypropylene, polyethylene; polyurethane; polyester; polystyrene; halopolymers including fluoropolymers and chloropolymers, polyamide, polyimide, acrylates, elastomeric rubber, and the like. As will be described in more detail below, protective clothing that is adapted for single use applications may not incorporate a fabric layer, whereas protective clothing that is adapted for a multi-use application will often include a fabric layer to improve durability and mechanical properties of the protective clothing.

The chemically protective layer 20 can be constructed of any material useful to protect a user from exposure to a dangerous chemicals, biologics, or other harmful gases or fluids. For example, the chemically protective layer 20 can include a polymeric layer. Particular examples of polymeric layers include fluoropolymer, and can particularly include a continuous layer consisting essentially of a fluoropolymer. Particular fluoropolymers can include polytetrafluoroethylene (PTFE), perfluoroalkoxy polymer (PFA), fluorinated ethylene-propylene (FEP), copolymer of tetrafluoroethylene, hexafluoropropylene and vinylidene fluoride (THV), copolymers of hexafluoropropylene (HFP) and vinylidene fluoride (VDF or VF2), terpolymers of tetrafluoroethylene (TFE), vinylidene fluoride (VDF) and hexafluoropropylene (HFP) as well as perfluoromethylvinylether (PMVE) containing specialties, polyethylenetetrafluoroethylene (ETFE), polyvinylidene fluoride (PVDF), polyvinylfluoride (PVF), polyethylenechlorotrifluoroethylene (ECTFE), polychlorotrifluoroethylene (PCTFE), poly(ethylene tetrafluoroethylene)fluoropolymer (PCTFE), or combinations thereof. In particular embodiments, the fluoropolymer can include polytetrafluoroethylene (PTFE), perfluoroalkoxy polymer (PFA), fluorinated ethylene-propylene (FEP), or combinations thereof.

In particular embodiments, the chemically protective layer 20, and particularly a fluoropolymer chemically protective layer, can have any number of primers or surface treatment on a major surface to improve coatability and/or adhesion. Such primers can include acrylics, polyurethanes, polyesters, vinylidene halides, polyolefines, epoxies, silanes and the like. Surface treatments can include flame, plasma and corona discharge treatment, ultraviolet radiation treatment, ozone treatment, electron beam treatment, chemical treatment and the like.

A particularly useful surface treatment preferred for fluoropolymer surface is the C-treatment, which refers to a method for modifying the surface by corona treatment in the presence of a solvent gas such as acetone. Not to be limited by theory, the method has been found to provide strong interlayer adhesion between a modified fluoropolymer and a non fluoropolymer interface (or a second modified fluoropolymer). C-treatment has been described in U.S. Pat. No. 6,726,979 and references therein, the teachings of which are incorporated herein in their entirety for all purposes.

In certain embodiments, the chemically protective layer 20 may not be present, depending on the intended use or environment for which the protective clothing is designed.

In certain embodiments, the anti-static layer 30 can include an antistatic agent and a binder.

Antistatic agents can primarily include electronically conductive materials which can be divided into two broad groups: (i) ionic conductors and (ii) electronic conductors. In ionic conductors charge is transferred by the bulk diffusion of charged species through an electrolyte. Negatively, for ionic conductors, the resistivity is dependent on temperature and humidity. The conductivity of an electronic conductor depends on electronic mobility rather than ionic mobility and is independent of humidity. As will be discussed in more detail below, electronically conductive antistatic agents can result in humidity independent resistivity performance and reusability of the article of protective clothing. Accordingly, in embodiments described herein, the antistatic agent can include an electronically conductive antistatic agent.

In certain embodiments, electronic conductors can include conjugated conducting polymers, conducting carbon particles including single- or multi-walled carbon nanotubes, graphene, reduced-graphene oxide, crystalline semiconductor particles, amorphous semiconductive fibrils, and continuous conductive metal or semiconducting thin films. In particular embodiments, the, electronically conductive metal-containing particles, can include semiconducting metal oxides or electronically conductive polymers. In even more particular embodiments, the electronically conductive polymers can include substituted or unsubstituted polythiophenes, substituted or unsubstituted polypyrroles, and substituted or unsubstituted polyanilines

Particular conductive metal-containing particles include inorganic oxides, metal antimonates, and inorganic non-oxides. Particularly suitable inorganic oxides include crystalline inorganic oxides such as zinc oxide, titania, tin oxide, alumina, indium oxide, silica, magnesia, barium oxide, molybdenum oxide, tungsten oxide, and vanadium oxide or composite oxides thereof. The conductive crystalline inorganic oxides can contain a “dopant” in the range from 0.01 to 30 mole percent, preferred dopants being aluminum or indium for zinc oxide, niobium or tantalum for titania, and antimony, niobium or halogens for tin oxide. Alternatively, the conductivity can be enhanced by formation of oxygen defects by methods well known in the art. The use of antimony-doped tin oxide is specifically contemplated.

Another useful category of electronically conductive metal-containing particles can include acicular doped metal oxides, acicular metal oxide particles, and acicular metal oxides containing oxygen deficiencies. In this category, acicular doped tin oxide particles, particularly acicular antimony-doped tin oxide particles, acicular niobium-doped titanium dioxide particles, and the like are preferred because of their large scale availability. The aforesaid acicular conductive particles preferably have a cross-sectional diameter less than or equal to 0.02 micron and an aspect ratio greater than or equal to 5:1.

In still further embodiments, the anti-static agent can include a conductive “amorphous” gel. Particular examples of such conductive amorphous gel include a vanadium oxide gel comprised of vanadium oxide ribbons or fibers. Such vanadium oxide gels may be prepared by any variety of methods, including but not specifically limited to melt quenching as described in U.S. Pat. No. 4,203,769, incorporated herein by reference, ion exchange as described in DE 4,125,758, incorporated herein by reference, or hydrolysis of a vanadium oxoalkoxide as claimed in WO 93/24584, incorporated herein by reference. The vanadium oxide gel can preferably doped with silver to enhance conductivity. Other methods of preparing vanadium oxide gels, which are well known in the literature, include reaction of vanadium or vanadium pentoxide with hydrogen peroxide and hydrolysis of VO.sub.2OAc or vanadium oxychloride.

In still further embodiments, the anti-static agent can include metal antimonates. Particular example of metal antimonates include metal antimonates having a rutile or rutile-related crystallographic structures and may be represented as M+2 Sb+5 2 O 6 (where M+2=Zn+2, Ni+2, Mg+2, Fe+2, Cu+2, Mn+2, Co+2) or M+3 Sb+5 O 4 (where M+3=In+3, Al+3, Sc+3, Cr+3, Fe+3). Several colloidal conductive metal antimonate dispersions are commercially available from Nissan Chemical Company in the form of aqueous or organic dispersions. Alternatively, the metal antimonite can be prepared by treating an aqueous solution of potassium antimonate with an aqueous solution of an appropriate metal salt (e.g., chloride, nitrate, sulfate) to form a gelatinous precipitate of the corresponding insoluble hydrate which may be converted to a conductive metal antimonate by suitable treatment.

Specific examples of electronically conductive inorganic non-oxides include metal nitrides, metal borides and metal silicides, which may be acicular or non-acicular in shape. Examples of these inorganic non-oxides include titanium nitride, titanium boride, titanium carbide, niobium boride, tungsten carbide, lanthanum boride, zirconium boride, molybdenum boride and the like. Examples of conductive carbon particles, can include carbon black and carbon fibrils or nanotubes with single walled or multi-walled morphology.

Suitable electronically conductive polymers include conjugated polymers such as substituted or unsubstituted aniline-containing polymers, substituted or unsubstituted thiophene-containing polymers, substituted or unsubstituted pyrrole-containing polymers, and poly(isothianaphthene) or derivatives thereof. These conducting polymers may be soluble or dispersible in organic solvents or water or mixtures thereof. Particular conducting polymers include polypyrrole styrene sulfonate (referred to as polypyrrole/poly(styrene sulfonic acid), 3,4-dialkoxy substituted polypyrrole styrene sulfonate, and 3,4-dialkoxy substituted polythiophene styrene sulfonate because of their color. The very particular embodiments, the electronically conductive polymers can include poly(3,4-ethylene dioxythiophene styrene sulfonate), such as Clevios P supplied by Heraeus.

In certain further embodiments, suitable electronically conductive anti-static agents can include semiconductive metal oxide particles, particularly acicular metal oxide particles, more preferably doped acicular metal oxide particles; metal antimonate particles and electronically conductive polymeric materials, or combinations thereof.

The anti-static agent can be present in the anti-static layer in any desired amount that is effective to produce the desired anti-static effect. In particular embodiments, the anti-static agent can be present in the anti-static layer in an amount of at least 0.1 wt. %, at least 2 wt. %, at least 5 wt. %, at least 10 wt. %, at least 15 wt. %, at least 20 wt. %, at least 25 wt. %, at least 30 wt. %, or even at least 40 wt. %, based on the total weight of the anti-static layer. In further embodiments, the anti-static agent can be present in the anti-static layer in an amount of no greater than 95 wt. %, no greater than 90 wt. %, no greater than 85 wt. %, no greater than 80 wt. %, no greater than 75 wt. %, no greater than 70 wt. %, or even no greater than 65 wt. %, based on the total weight of the anti-static layer. In even more particular embodiments, the anti-static agent can be present in the anti-static layer in an amount within a range of any of the maximum and minimum values described herein, such as, 0.1 wt. % to 80 wt. %, or even in a range of 5 wt. % to 70 wt. %, based on the total weight of the anti-static layer.

The anti-static agent can generally be uniformly dispersed within the anti-static layer or continuous across a major surface of the anti-static layer. For example, a uniform concentration or continuous nature of the anti-static layer leads to a uniform nature of the anti-static effect. In an explosive environment, areas of reduced concentration or non-continuity from non-uniformly dispersed anti-static agents, can cause discrete defective areas which can lead to the generation of a spark and potential explosion in an explosive environment. However, in certain embodiments an interconnected conductive network or grid may be applied to optimize surface conductivity and transparency, as disclosed in U.S. Pat. Nos. 7,083,885 and 7,153,620 (incorporated herein by reference) while taking special care to minimize discrete pockets of insulating areas as described above.

The anti-static layer can further include a binder. In certain embodiments, the binder can include a polymeric material. For example, in particular embodiments, the binder can include an acrylate, a polyurethane, a polyester, a silicone, a halopolymer including a fluoropolymer or a chloropolymer, a polyolefin, a polystyrene, a polyamide, a polyimide, an elastomeric rubber, or combinations thereof.

When used, the binder can be present in any effective amount. In particular embodiments, the binder can be present in the anti-static layer in an amount of at least 0.1 wt. %, at least 2 wt. %, at least 5 wt. %, at least 10 wt. %, at least 15 wt. %, at least 20 wt. %, at least 25 wt. %, at least 30 wt. %, or even at least 40 wt. % based on the total weight of the anti-static layer. In further embodiments, the binder can be present in the anti-static layer in an amount of no greater than 99.9 wt. %, no greater than 95 wt. %, no greater than 90 wt. %, no greater than 85 wt. %, no greater than 80 wt. %, no greater than 75 wt. %, or even no greater than 70 wt. % based on the total weight of the anti-static layer. In even more particular embodiments, the binder can be present in the anti-static layer in an amount within a range of any of the maximum and minimum values described herein, such as, 0.1 wt. % to 99.9 wt. %, or even in a range of 10 wt. % to 80 wt. %, based on the total weight of the anti-static layer.

The anti-static layer can have any desired thickness. In certain embodiments, the anti-static layer can have a thickness of at least at least 10 nm, at least 20 nm, at least 30 nm, at least 40 nm, or even at least 50 nm. Further, the anti-static layer can have a thickness of no greater than 100 mm, no greater than 10 mm, no greater than 5 mm, or even no greater than 1 mm. In even further embodiments, the anti-static layer can have a thickness in a range of any of the maximum and minimum values described above, such as from 10 nm to 100 mm, or even in a range of 50 nm to 1 mm.

The anti-static layer can further include any useful additive. For example, the anti-static layer can further include an additive including charge control agents, conductive particles or polymers such as salt or other ionic conductors, crosslinking agents or hardeners, soluble and/or solid particle dyes, anti-foggants, inorganic or organic particles or fillers, dispersants, lubricants, plasticizers, antioxidants, voiding agents, colorants or tints, roughening agent, slip agent, UV absorbers, refractive index matching material, release agents, flame retardants, matte beads, or combinations thereof.

The anti-static layer can be substantially transparent. For example, the anti-static layer can have a visible light transmission of at least 40%, at least 50%, at least 60%, at least 70%, at least 75%, at least 80%, at least 85%, at least 90%, at least 94%, at least 97%, or even at least 98%. In particular embodiments, the anti-static layer can have a visible light transmission of at least 70%. Further, the anti-static layer can have a transparency of no greater than 99.9%, no greater than about 99%, or even no greater than about 97%. In even further embodiments, the anti-static layer can have a transparency in a range of any of the maximum and minimum values described above, such as from 40% to 99.9%, or even from 70% to 99%. It is particularly noted that use of a carbon black in a sufficient amount to induce a suitable anti-static effect for protective clothing is not “substantially transparent” as this phrase is used herein, and can not achieve a transparency of at least 40%. A particular advantage of the present disclosure is the discovery of a synergistic combination of materials capable of inducing a suitable anti-static effect for protective clothing while exhibiting the transparency values described herein. A substantially transparent anti-static layer allows for a choice of any desired color for the protective clothing.

As described herein, visible light transmission (% VLT) is a measure of the visible light that can pass through a material, particularly an antistatic layer. Specifically, % VLT is the intensity ratio of the transmitted light to incident light passing through a layer and can be determined by measuring the optical density of the layer using a densitometer (such as an X-rite densitometer) as described in U.S. Pat. No. 7,410,825, which is incorporated herein by reference, or directly by an instrument such as BYK Gardner Haze-Gard Plus.

The electrical resistivity of the anti-static layer can help to describe and quantify the anti-static layer's anti-static effect. The electrical resistivity can be measured and described based on the following types of resistivity measurements: 1) surface electrical resistivity (SER), which is measure of the electrical resistance of an exposed surface, sometimes referred to as “sheet resistance”; and/or2) internal resistivity, also known as water electrode resistance (WER) which is a measure of the electrical resistance of a buried internal layer.

In particular embodiments, the anti-static layer described herein can have a surface electrical resistivity (SER), and/or a water electrode resistivity (WER) of no greater than 10¹² ohms/square, no greater than 10¹¹ ohms/square, no greater than 10¹⁰ ohms/square, no greater than 10⁹ ohms/square, or even no greater than 10⁸ ohms/square. Further, the anti-static layer described herein can have a surface electrical resistivity (SER), and/or a water electrode resistivity (WER) of at least 10⁶ ohms/square, at least 10⁷ ohms/square, or even at least 10⁸ ohms/square. Moreover, the anti-static layer described herein can have a surface electrical resistivity (SER), and/or a water electrode resistivity (WER) in a range of any of the maximum and minimum values described above, such as, in a range of 10⁶ ohms/square to 10¹² ohms/square, or even 10⁶ ohms/square to 10¹¹ ohms/square.

As described herein, “surface electrical resistivity (SER)” can be measured with a Keithly model 616 digital electrometer using a two point DC probe by a method similar to that described in U.S. Pat. No. 2,801,191 (col. 4, lines 4-34), which is incorporated herein by reference for all useful purposes. Internal resistivity or “water electrode resistivity (WER)” can be measured by the procedures described in R. A. Elder, “Resistivity Measurement on Buried Conductive Layers,” EOS/ESD Symposium Proceedings, September 1990, pages 251-254, which is incorporated herein by reference for all useful purposes.

Another particular advantage of the present disclosure is the creation of composites and articles for protective clothing in which the anti-static performance (i.e. electrical resistivity) is generally independent of the surrounding humidity. For example, the composites and articles described herein can have the electrical resistivity values described above across a broad range of relative humidity. In particular embodiments, the composites and articles for protective clothing described herein can have a variance in the electrical resistivity properties (i.e. surface electrical resistivity (SER), or a water electrode resistivity (WER)) of less than 2 orders of magnitude or less than 1.5 orders of magnitude, or even less than 1 order of magnitude within the entire range of from 5% to 95% relative humidity. For example, for composites and articles having an average electrical resistivity of 10⁶ ohms/square, that electrical resistivity value would not change more than 2 or 1.5 order of magnitude or even 1 order of magnitude when changing the relative humidity from 5% to 95%. It is particularly noted that generally, ionic conducting materials are not effective in low humidities, and the electrical resistivity of anti-static layers containing a traditional amount of ionic conducting antistatic agents will typically vary by more than 2 orders of magnitude across a range of relative humidity of 5% to 95%.

Composites and articles for protective clothing can be adapted to be either a single-use or a multiple use product (i.e. reusable). Traditionally, reusable applications are multilayer composites, and often have a fabric layer within the composite to provide high mechanical strength to accommodate multiple use whereas, single use applications typically may not need such strength. It is to be understood that the composites and articles described herein can be adapted for either a single-use or a multiple use application, and particularly a multiple use application. Importantly, in multiple use applications, the anti-static layer must be able to provide the anti-static effect after one or more uses and/or launderings (also referred to as washings). As used herein, the words “laundering” or “washing” refer to washing with tepid water and soap for a few minutes. It is a particular advantage of the present disclosure to have multiple-use composites and articles for protective clothing which can maintain a desired anti-static effect even after one or more uses and/or launderings. For example, the composites and articles described herein can have the electrical resistivity values described above, (such as 10¹⁰ ohms/square) after at least 1 washing, at least 2 washings, at least 3 washings, at least 4 washings, at least 5 washings, at least 6 washings, at least 10 washings, or even at least 15 washings.

The composite or articles described above can further be configured to exhibit a desired level of flame retardant behavior. For example, in particular embodiments, the composite or articles described herein can have a UL 94 Flame Rating of at least V-1 or even at least V-2. Moreover, in further embodiments, the composite or articles described herein can have a UL 94 Flame Rating of at least VTM 1 or even at least VTM 2. The UL 94 Flame rating is an art recognized standard for flame retardant behavior, and its measurement technique is well known in the art. An example description of the measurement techniques and rating table can found at http://www.ides.com/property_descriptions/UL94.asp, accessed Aug. 6, 2013.

The composite or articles described above can further include indicia. The indicia can be in the form of a stich, a stamp, or area of different color. The indicia can identify a manufacturer or other desired logo or name.

As described above, the composites and articles can be adapted for use as protective clothing. Protective clothing comes in many different constructions, depending on the intended use. Protective clothing can be differentiated from other types of clothing by their configuration and ability to protect a user against different types of dangers such as radiation, fire, biologically active environments, chemically active environments, and the like.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Item 1. A composite for protective clothing or an article of protective clothing, wherein the composite or article comprises an anti-static layer, and wherein the anti-static layer comprises an electronically conductive anti-static agent, and wherein the anti-static layer has a visible light transmission of at least 70%.

Item 2. A composite or an article for protective clothing, comprising an anti-static layer, wherein the anti-static layer has a surface electrical resistivity (SER) and/or a water electrode resistivity (WER) of no greater than 10¹¹ ohms/square; and a visible light transmission of at least 70%.

Item 3. A composite or an article for protective clothing, comprising an anti-static layer, wherein the anti-static layer has an electrical resistivity, measured in ohms/square, which varies by no more than 1 order of magnitude over a range of relative humidity of 5% to 95%, and a visible light transmission of at least 70%.

Item 4. A composite or an article of protective clothing comprising:
a fabric layer;
a chemically protective layer; and
an anti-static layer, wherein at least one of the following is true of the antistatic layer:
   i. the antistatic layer comprises an antistatic agent comprising an electronically conductive material, and wherein the antistatic layer has a visible light transmission of at least 70%;
   ii. the anti-static layer has a surface electrical resistivity (SER) and/or or a water electrode resistivity (WER) of no greater than 10¹¹ ohms/square; and a visible light transmission of at least 70%; or
   iii. the anti-static layer has an electrical resistivity, measured in ohms/square, which varies by no more than 1.5 order of magnitude over a range of relative humidity of 5% to 95%, and a visible light transmission of at least 70%;

Item 5. A method for forming a composite for protective clothing or an article of protective clothing, comprising:
providing an anti-static composition; and
forming an anti-static layer as an intermediate or an outer layer in the composite or article;
wherein at least one of the following is true of the antistatic layer:
   iv. the antistatic layer comprises an antistatic agent comprising an electronically conductive material, and wherein the antistatic layer has a visible light transmission of at least 70%;
   v. the anti-static layer has a surface electrical resistivity (SER) and/or a water electrode resistivity (WER) of no greater than 10¹¹ ohms/square, and a visible light transmission of at least 70%; or
   vi. the anti-static layer has an electrical resistivity, measured in ohms/square, which varies by no more than 1.5 order of magnitude over a range of relative humidity of 5% to 95%, and a visible light transmission of at least 70%;

Item 6. The composite, article or method of any one of the preceding items, wherein the antistatic agent comprises an electronic conductor.

Item 7. The composite, article or method of any one of the preceding items, wherein the antistatic agent comprises a metal containing particle, an electronically conductive polymer, or combinations thereof.

Item 8. The composite, article or method of any one of the preceding items, wherein the antistatic agent comprises a semiconductive metal oxide.

Item 9. The composite, article or method of any one of the preceding items, wherein the antistatic agent comprises a semiconductive metal oxide which is acicular.

Item 10. The composite, article or method of any one of the preceding items, wherein the antistatic agent comprises zinc oxide, titania, tin oxide, indium oxide, silica, molybdenum oxide, tungsten oxide, vanadium oxide or combinations thereof.

Item 11. The composite, article or method of any one of the preceding items, wherein the antistatic agent comprises antimony doped tin oxide, zinc antimonate, vanadium oxide, or combinations thereof.

Item 12. The composite, article or method of any one of the preceding items, wherein the antistatic agent comprises an electronically conductive polymer.

Item 13. The composite, article or method of any one of the preceding items, wherein the antistatic agent comprises a transparent electronically conductive polymer selected from the group consisting of polythiophene, polyaniline, polypyrrole, and combinations thereof.

Item 14. The composite, article or method of any one of the preceding items, wherein the anti-static agent is present in the anti-static layer in an amount of at least 0.1 wt. %, at least 2 wt. %, at least 5 wt. %, at least 10 wt. %, at least 15 wt. %, at least 20 wt. %, at least 25 wt. %, at least 30 wt. %, or even at least 40 wt. %; no greater than 95 wt. %, no greater than 90 wt. %, no greater than 85 wt. %, no greater than 80 wt. %, no greater than 75 wt. %, no greater than 70 wt. %, or even no greater than 65 wt. %; or in a range of 0.1 wt. % to 80 wt. %, or even in a range of 5 wt. % to 70 wt. %, based on the total weight of the anti-static layer.

Item 15. The composite, article or method of any one of the preceding items, wherein the anti-static agent is generally uniformly dispersed within the anti-static layer.

Item 16. The composite, article or method of any one of the preceding items, wherein the anti-static agent is generally continuous across a major surface of the anti-static layer.

Item 17. The composite, article or method of any one of the preceding items, wherein the antistatic layer further comprises a binder.

Item 18. The composite, article or method of any one of the preceding items, wherein the antistatic layer further comprises a binder comprising an acrylate, a polyurethane, a polyester, a silicone, a halopolymer including a fluoropolymer, a polyolefin, a polystyrene, a polyamide, a polyimide, an elastomeric rubber, or combinations thereof.

Item 19. The composite, article or method of any one of the preceding items, wherein the antistatic layer further comprises a binder present in the anti-static layer in an amount of at least 0.1 wt. %, at least 2 wt. %, at least 5 wt. %, at least 10 wt. %, at least 15 wt. %, at least 20 wt. %, at least 25 wt. %, at least 30 wt. %, or even at least 40 wt. %; no greater than 99.9 wt. %, no greater than 95 wt. %, no greater than 90 wt. %, no greater than 85 wt. %, no greater than 80 wt. %, no greater than 75 wt. %, or even no greater than 70 wt. %; or within a range of 0.1 wt. % to 99.9 wt. %, or eve in a range of 10 wt. % to 80 wt. %, based on the total weight of the anti-static layer.

Item 20. The composite, article or method of any one of the preceding items, wherein the anti-static layer has an average thickness of at least 10 nm, at least 20 nm, at least 30 nm, at least 40 nm, or even at least 50 nm; no greater than 100 mm, no greater than 10 mm, no greater than 5 mm, or even no greater than 1 mm; or in a range of 10 nm to 100 mm, or even in a range of 50 nm to 1 mm.

Item 21. The composite, article or method of any one of the preceding items, wherein the composite or article has a UL 94 Flame Rating of at least VTM-1.

Item 22. The composite, article or method of any one of the preceding items, wherein the composite or article further comprises a fluoropolymer layer.

Item 23. The composite, article or method of any one of the preceding items, wherein the composite or article further comprises a fluoropolymer layer comprising a fluoropolymer comprising fluoropolymers can include polytetrafluoroethylene (PTFE), perfluoroalkoxy polymer (PFA), fluorinated ethylene-propylene (FEP), copolymer of tetrafluoroethylene, hexafluoropropylene and vinylidene fluoride (THV), copolymers of hexafluoropropylene (HFP) and vinylidene fluoride (VDF or VF2), terpolymers of tetrafluoroethylene (TFE), vinylidene fluoride (VDF) and hexafluoropropylene (HFP) as well as perfluoromethylvinylether (PMVE) containing specialties, polyethylenetetrafluoroethylene (ETFE), polyvinylidene fluoride (PVDF), polyvinylfluoride (PVF), polyethylenechlorotrifluoroethylene (ECTFE), polychlorotrifluoroethylene (PCTFE), poly(ethylene tetrafluoroethylene)fluoropolymer (PCTFE), or combinations thereof.

Item 24. The composite, article or method of any one of the preceding items, wherein the composite or article further comprises a fluoropolymer layer comprising a fluoropolymer comprising polytetrafluoroethylene (PTFE), perfluoroalkoxy polymer (PFA), fluorinated ethylene-propylene (FEP), vinylidene fluoride (VDF or VF2), copolymer of tetrafluoroethylene, hexafluoropropylene and vinylidene fluoride (THV), polyethylenetetrafluoroethylene (ETFE), polyvinylidene fluoride (PVDF), polyvinylfluoride (PVF), or combinations thereof.

Item 25. The composite, article or method of any one of the preceding items, wherein the composite or article further comprises a fabric layer.

Item 26. The composite, article or method of any one of the preceding items, wherein the composite or article further comprises a fabric layer, and wherein the fabric layer comprises a woven material.

Item 27. The composite, article or method of any one of the preceding items, further comprising a fabric layer, and wherein the fabric layer comprises a non-woven material.

Item 28. The composite, article or method of any one of the preceding items, further comprising a fabric layer, and wherein the fabric layer comprises a spunbonded fabric, a meltspun fabric, a knit fabric, or combinations thereof.

Item 29. The composite, article or method of any one of the preceding items, further comprising a thermoplastic layer.

Item 30. The composite, article or method of any one of the preceding items, further comprising a layer comprising polypropylene, polyethylene, polyester, polyurethane or combinations thereof.

Item 31. The composite, article or method of any one of the preceding items, further comprising an elastomeric layer.

Item 32. The composite, article or method of item 31, wherein the elastomeric layer is disposed between a fabric layer and the anti-static layer.

Item 33. The composite, article or method of any one of the preceding items, wherein the antistatic layer has an electrical resistivity substantially independent of a surrounding humidity.

Item 34. The composite, article or method of any one of the preceding items, wherein the anti-static layer has an electrical resistivity, measured in ohms/square, which varies by no more than 2 or no more than 1.5 or even no more than 1 order of magnitude over a range of relative humidity of 5% to 95%

Item 35. The composite, article or method of any one of the preceding items, wherein the antistatic layer is substantially transparent.

Item 36. The composite, article or method of any one of the preceding items, wherein the antistatic layer has a visible light transmission of at least 40%, at least 50%, at least 60%, at least 70%, at least 75%, at least 80%, at least 85%, at least 90%, at least 94%, or even at least 98%.

Item 37. The composite, article or method of any one of the preceding items, wherein the antistatic layer has a visible light transmission of at least 70%.

Item 38. The composite, article or method of any one of the preceding items, wherein the antistatic layer has a visible light transmission of no greater than 99.9%, no greater than about 99%, or even no greater than about 97%.

Item 39. The composite, article or method of any one of the preceding items, wherein the antistatic layer has a visible light transmission in a range of from 40% to 99.9%, or even from 70% to 99%.

Item 40. The composite, article or method of any one of the preceding items, wherein the antistatic layer has a surface electrical resistivity (SER) and/or a water electrode resistivity (WER) of no greater than 10¹² ohms/square, no greater than 10¹¹ ohms/square, no greater than 10¹⁰ ohms/square, no greater than 10⁹ ohms/square, or even no greater than 10⁸ ohms/square.

Item 41. The composite, article or method of any one of the preceding items, wherein a variation in surface electrical resistivity (SER), and/or a water electrode resistivity (WER) of the anti-static layer across a major surface of the anti-static layer varies by no more than two orders of magnitude, or even varies by no more than one order of magnitude as measured in ohms/square.

Item 42. The composite, article or method of any one of the preceding items, wherein the article has a surface electrical resistivity (SER), and/or a water electrode resistivity (WER) of no greater than 10¹² ohms/square, no greater than 10¹¹ ohms/square, no greater than 10¹⁰ ohms/square, no greater than 10⁹ ohms/square, or even no greater than 10⁸ ohms/square after at least 1 washing, at least 2 washings, at least 3 washings, at least 4 washings, at least 5 washings, at least 6 washings, at least 10 washings, or even at least 15 washings.

Item 43. The composite, article or method of any one of the preceding items, wherein the anti-static layer is disposed as an outermost layer of the composite or article.

Item 44. The composite, article or method of any one of the preceding items, wherein the anti-static layer is disposed directly adjacent an outermost layer of the composite or article.

Item 45. The composite, article or method of any one of the preceding items, wherein the anti-static layer is disposed as an intermediate layer of the composite or article.

Item 46. The composite, article or method of any one of the preceding items, further comprising a fabric layer, and wherein the anti-static layer is disposed directly adjacent the fabric layer.

Item 47. The composite, article or method of any one of the preceding items, further comprising a chemically protective layer, and wherein the anti-static layer is disposed directly adjacent a major surface of the chemically protective layer.

Item 48. The composite, article or method of any one of the preceding items, wherein the composite or article is resistant to radiation, fire, chemical agents, biological agents, or a combination thereof.

Item 49. The composite, article or method of any one of the preceding items, wherein the anti-static layer further comprises an additive comprising charge control agents, conductive particles or polymers such as salt or other ionic conductors, crosslinking agents or hardeners, soluble and/or solid particle dyes, anti-foggants, inorganic or organic particles or fillers, dispersants, lubricants, plasticizers, antioxidants, voiding agents, colorants or tints, roughening agent, slip agent, UV absorbers, refractive index matching material, release agents, flame retardants, matte beads or combinations thereof salt other ionic conductors, or any combination thereof.

Item 50. The composite, article or method of any one of the preceding items, further comprising indicia.

Item 51. The composite, article or method of any one of the preceding items, wherein the article or composite is configured to be reusable.

Item 52. The composite, article or method of any one of the preceding items, wherein the composite or article is flexible.

### EXAMPLES

The constituents used for various layers of the Examples of embodiments of the present disclosure are comprised of the following commercially available materials:
a. FS-10D, an aqueous dispersion of acicular conductive tin oxide, supplied by Ishihara Corporation;
b. Clevios P, an aqueous dispersion of poly(3,4-ethylene dioxythiophene styrene sulfonate), supplied by Heraeus;
c. Neorez R 9679, a waterborne aliphatic polyurethane dispersion supplied by DSM Neoresins;
d. Zonyl FSO, an ethoxylated nonionic fluorosurfactant supplied by Dupont; and
e. Capstone FS-35, partially fluorinated alcohol substituted glycol based nonionic surfactant supplied by Dupont.

The substrates used for coating the antistatic layers of the Examples of the invention comprised of the following materials:
a. Transparent PVC sheets, to be referred to as PVC;
b. Protective clothing material comprising calendared Hypalon on polyester fabric which is laminated to a fluoropolymer film which in turn is laminated to a TPU film, to be referred to as Calendared Hypalon;
c. Same as Calendared Hypalon but with an additional polyurethane topcoat on the Hypalon layer, to be referred to as Calendared Hypalon with PU topcoat.

The details of the transparent antistatic coating compositions are provided below in Table 1.

TABLE 1

| | Neorez R | | | | Capstone | Zonyl |
|---|---|---|---|---|---|---|
| Antistat | 9679 | FS-10D | Clevios P | Water | FS 35 | FSO |
| Composition | gms | gms | gms | gms | gms | gms |
| A | 43.24 | 20 | | 36.76 | 1 | |
| B | 37.84 | 30 | | 32.16 | 1 | |
| C | 32.43 | 40 | | 27.57 | 1 | |
| D | 27.03 | 50 | | 22.97 | 1 | |
| E | 38.51 | | 57.69 | 3.79 | | 1 |
| F | 39.32 | | 34.62 | 26.06 | | 1 |

The components identified in Table 1 were mixed together for 5 to 10 minutes under ambient conditions. The compositions were coated on substrates with a Mayer Rod, as well known in the art, such that the thickness of the dried coating is about 2 microns as indicated in Table 2 below. Selected performance characteristics are provided below in Table 2, including the surface electrical resistance and % VLT for select Examples. The tests for surface electrical resistance and % VLT were conducted as described herein. The PVC was measured without the antistatic composition to determine the effect on % VLT for antistatic layer.

TABLE 2

| | | | | Antistatic | | | % VLT |
|---|---|---|---|---|---|---|---|
| | | | | layer | | % VLT | (corrected |
| | | Antistat | Drying | thickness | SER | (with | for |
| Sample | Substrate | comp. | condition | (dry) | ohms/square | substrate) | substrate) |
| Example 1 | Calendared | A | 107° C. for | 2 m | 10⁹ | | |
| invention | Hypalon | | 10 minutes | | | | |
| Example 2 | Calendared | B | 107° C. for | 2 m | 10⁸ | | |
| invention | Hypalon | | 10 minutes | | | | |
| Example 3 | Calendared | C | 107° C. for | 2 m | 10⁷ | | |
| invention | Hypalon | | 10 minutes | | | | |
| Example 4 | Calendared | D | 107° C. for | 2 m | 10⁶ | | |
| invention | Hypalon | | 10 minutes | | | | |
| Example 5 | Calendared | E | 107° C. for | 2 m | 10⁶ | | |
| invention | Hypalon with | | 45 minutes | | | | |
| | PU topcoat | | | | | | |
| Example 6 | Calendared | F | 107° C. for | 2 m | 10⁶ | | |
| invention | Hypalon with | | 45 minutes | | | | |
| | PU topcoat | | | | | | |
| Sample A | Calendared | None | N/A | none | >10¹² | | |
| comparative | Hypalon | | | | | | |
| Sample B | Calendared | None | N/A | none | >10¹² | | |
| comparative | Hypalon with | | | | | | |
| | PU topcoat | | | | | | |
| Example 7 | PVC | A | 107° C. for | 2 m | | 88 | 97 |
| invention | | | 10 minutes | | | | |
| Example 8 | PVC | B | 107° C. for | 2 m | | 88 | 97 |
| invention | | | 10 minutes | | | | |
| Example 9 | PVC | C | 107° C. for | 2 m | | 88 | 97 |
| invention | | | 10 minutes | | | | |
| Example 10 | PVC | D | 107° C. for | 2 m | | 88 | 97 |
| invention | | | 10 minutes | | | | |
| Example 11 | PVC | E | 107° C. for | 2 m | | 81 | 89 |
| invention | | | 45 minutes | | | | |
| Example 12 | PVC | F | 107° C. for | 2 m | | 84 | 93 |
| invention | | | 45 minutes | | | | |

It is clear from Table 2 that the antistatic layers of Examples 1-6, provide very low surface resistance (SER orders of magnitude less than 10¹² ohms/square) indicating their significant and unexpected effectiveness in static dissipation. Comparative Samples A and B without the antistatic layer of the invention provide very high surface resistance (SER>10¹² ohms/square). When coated on the transparent PVC substrate the antistatic layers according to certain embodiments of the disclosure, Examples 7-12, demonstrate their high transparency through significantly high values of % VLT. When corrected for the % VLT of the PVC substrate, Examples 7-10 provide % VLT of >95% whereas Examples 11 and 12 provide % VLT of >85%, indicating even further excellent visible light transmission characteristics of these embodiments of antistatic layers.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1-20. (canceled)

21. A composite for protective clothing, wherein the composite comprises an anti-static layer, and wherein the anti-static layer comprises an electronically conductive anti-static agent, and wherein the anti-static layer has a visible light transmission of at least 70%.

22. A composite for protective clothing, the composite comprising an anti-static layer, wherein the anti-static layer comprises an anti-static agent, and wherein the anti-static layer has an electrical resistivity, measured in ohms/square, which varies by no more than 1 order of magnitude over a range of relative humidity of 5% to 95%, and a visible light transmission of at least 70%.

23. A composite for protective clothing, the composite comprising:
a fabric layer;
a chemically protective layer; and
an anti-static layer, wherein at least one of the following is true of the antistatic layer:
i. the antistatic layer comprises an antistatic agent comprising an electronically conductive material, and wherein the antistatic layer has a visible light transmission of at least 70%;
ii. the anti-static layer has a surface electrical resistivity (SER) and/or or a water electrode resistivity (WER) of no greater than 10¹¹ ohms/square; and a visible light transmission of at least 70%; or
iii. the anti-static layer has an electrical resistivity, measured in ohms/square, which varies by no more than 1.5 order of magnitude over a range of relative humidity of 5% to 95%, and a visible light transmission of at least 70%;

24. The composite of claim 21, wherein the antistatic agent comprises a metal containing particle, an electronically conductive polymer, or combinations thereof.

25. The composite of claim 21, wherein the antistatic agent comprises a semiconductive metal oxide.

26. The composite of claim 21, wherein the antistatic agent comprises zinc oxide, titania, tin oxide, indium oxide, silica, molybdenum oxide, tungsten oxide, vanadium oxide or combinations thereof.

27. The composite of claim 21, wherein the antistatic agent comprises an electronically conductive polymer.

28. The composite of claim 21, wherein the antistatic agent comprises a transparent electronically conductive polymer selected from the group consisting of polythiophene, polyaniline, polypyrrole, and combinations thereof.

29. The composite of claim 21, wherein the composite or article has a UL 94 Flame Rating of at least VTM-1.

30. The composite of claim 21, wherein the antistatic layer has an electrical resistivity substantially independent of a surrounding humidity.

31. The composite of claim 21, wherein the anti-static layer has an electrical resistivity, measured in ohms/square, which varies by no more than 2 orders of magnitude over a range of relative humidity of 5% to 95%

32. The composite of claim 21, wherein the antistatic layer has a visible light transmission of at least 80%.

33. The composite of claim 21, wherein the antistatic layer has a surface electrical resistivity (SER) and/or a water electrode resistivity (WER) of no greater than 10¹¹ ohms/square.

34. The composite of claim 21, wherein the article is adapted to have a surface electrical resistivity (SER), and/or a water electrode resistivity (WER) of no greater than 10¹² ohms/square after at least 5 washings.

35. The composite of claim 21, wherein the composite is resistant to radiation, fire, chemical agents, biological agents, or a combination thereof.

36. An article of protective clothing comprising the composite of claim 1.

37. The composite of claim 22, wherein the antistatic layer has an electrical resistivity substantially independent of a surrounding humidity.

38. The composite of claim 22, wherein the anti-static layer has an electrical resistivity, measured in ohms/square, which varies by no more than 2 orders of magnitude over a range of relative humidity of 5% to 95%

39. The composite of claim 22, wherein the antistatic layer has a visible light transmission of at least 80%.

40. The composite of claim 23, wherein the anti-static layer has an electrical resistivity, measured in ohms/square, which varies by no more than 2 orders of magnitude over a range of relative humidity of 5% to 95%, and wherein the antistatic layer has a visible light transmission of at least 70%.
